(19) United States
(12) Patent Application Publication
(10) Pub. No.: US 2008/0022702 A1
(43) Pub. Date: Jan. 31, 2008

(54) Compressed Air Aftercooler With Integral Moisture Separator

(76) Inventors: David F. Fijas, Depew, NY (US); Timothy J. Galus, Hamburg, NY (US)

Correspondence Address: JAECKLE FLEISCHMANN & MUGEL, LLP, 190 Linden Oaks, ROCHESTER, NY, 14625-2812, US

(21) Appl. No.: 11/836,468

(22) Filed: Aug. 9, 2007

Related U.S. Application Data
(63) Continuation-in-part of application No. 11/722,042.
(60) Provisional application No. 60/637,055, filed on Dec. 17, 2004.

(51) Int. Cl. B01D 53/00; F25D 17/06

(52) U.S. Cl. 62/93; 95/39

(57) ABSTRACT

A system for providing cooled compressed air free of entrained moisture. A housing surrounds a heat exchanger and has an inlet for passage of hot compressed air into an input plenum of the housing and an outlet plenum having an outlet for the cooled and dried compressed air. The bottom of the output plenum extends below the bottom of the heat exchanger to form a trough which collects condensate that collects on the plates of the heat exchanger, flows to the bottom of the heat exchanger, and is pushed by the flow of the compressed air to the output plenum. A shield is placed between the outlet and the heat exchanger to prevent condensate spewed from the plates of the heat exchanger from passing directly across the outlet opening or directly into the outlet opening.

### RELATED APPLICATIONS

The present application is a continuation-in-part of U.S. patent application Ser. No. 11/722,042, filed Jun. 18, 2007 which claims priority to International Application PCT/US2005/045366 filed Dec. 15, 2005 which in turn claims priority to U.S. Provisional Application Ser. No. 60/637,055 filed Dec. 17, 2004.

### TECHNICAL FIELD

The present invention relates to the art of heat transfer; more particularly, to heat exchangers for cooling adiabatically compressed air before delivery for use; and most particularly to a compressed air aftercooler including integral passive moisture separation means for removing entrained water from cooled compressed air before delivery for use.

### BACKGROUND OF THE INVENTION

Compressed air is widely used in many industrial processes. Typically, air at ambient temperature, pressure, and dew point is adiabatically compressed by known means, such as a motor- or engine-driven piston compressor, to many times atmospheric pressure. In accordance with Boyle's Law, PV=nRT, during adiabatic compression the absolute temperature in a compressed air tank of constant volume increases in direct proportion to the increase in absolute pressure.

In many applications, it is desirable to cool the compressed air before it is delivered to a header for use. In the prior art, such cooling is typically accomplished by passing the compressed air through one side of a conventional heat exchanger while passing air at ambient pressure and temperature through the other side. A known problem in the art is that such cooling of compressed air immediately produces condensation of water in the heat exchanger. It is generally undesirable that the condensate be delivered for use with the cooled compressed air; thus in the prior art sumps or active demoisturizing means may be provided for collecting and removing condensate.

What is needed in the art is an improved moisture separation system, preferably passive and preferably formed integrally with an air compression aftercooler.

It is a primary object of the invention to provide cooled compressed air for use substantially free of entrained moisture.

### SUMMARY OF THE INVENTION

Briefly described, a system for providing cooled compressed air free of entrained moisture comprises a housing having an inlet for receiving hot compressed air, a heat exchanger, an outlet plenum and an outlet for passing cooled and dried compressed air. At least a portion of a bottom of the output plenum may be recessed and may be lined with a moisture separating material, and a drain for passing condensate formed in the heat exchanger. In a preferred embodiment, a shield is placed between the outlet and the heat exchanger to prevent condensate spewed from the plates of the heat exchanger from passing directly across the outlet opening or directly into the outlet opening.

### BRIEF DESCRIPTION OF THE DRAWINGS

The present invention will now be described, by way of example, with reference to the accompanying drawings, in which:

FIG. 1 is a semi-schematic drawing showing a top layout of a compressed air aftercooler and passive moisture-removal improvement in accordance with the invention;

FIG. 2 is a semi-schematic drawing showing a side layout of the compressed air aftercooler of FIG. 1;

FIG. 3 is a semi-schematic drawing showing a side layout of the compressed air aftercooler of FIG. 1 that has been modified;

FIG. 4 is a semi-schematic drawing showing a side layout of the compressed air aftercooler of FIG. 1 with a different modification than shown in FIG. 3;

FIG. 5 is a semi-schematic drawing of an alternate embodiment of the lower portion of FIG. 2;

FIG. 6 is a semi-schematic drawing showing the top layout of FIG. 1 with a modified condensate shield;

FIG. 7 is a semi-schematic drawing showing a side layout of the compressed air aftercooler of FIG. 6;

FIG. 8 is a semi-schematic drawing showing a top layout of an alternative embodiment of a compressed air aftercooler and passive moisture-removal improvement in accordance with the invention;

FIG. 9 is a semi-schematic drawing showing a side layout of the compressed air aftercooler of FIG. 8;

FIG. 10 is a perspective view of an alternate embodiment of the invention;

FIG. 11 is the view of FIG. 10 with the moisture separator shown in section;

FIG. 12 is a perspective view thereof opposite to the view seen in FIG. 10;

FIG. 13 is a side elevational view of the sectioned moisture removal part seen in FIG. 11; and

FIG. 14 is a bottom plan view thereof.

It will be appreciated that for purposes of clarity and where deemed appropriate, reference numerals have often been repeated in the figures to indicate corresponding features, and that the various elements in the drawings have not necessarily been drawn to scale in order to better show the features of the invention.

### DESCRIPTION OF THE PREFERRED EMBODIMENTS

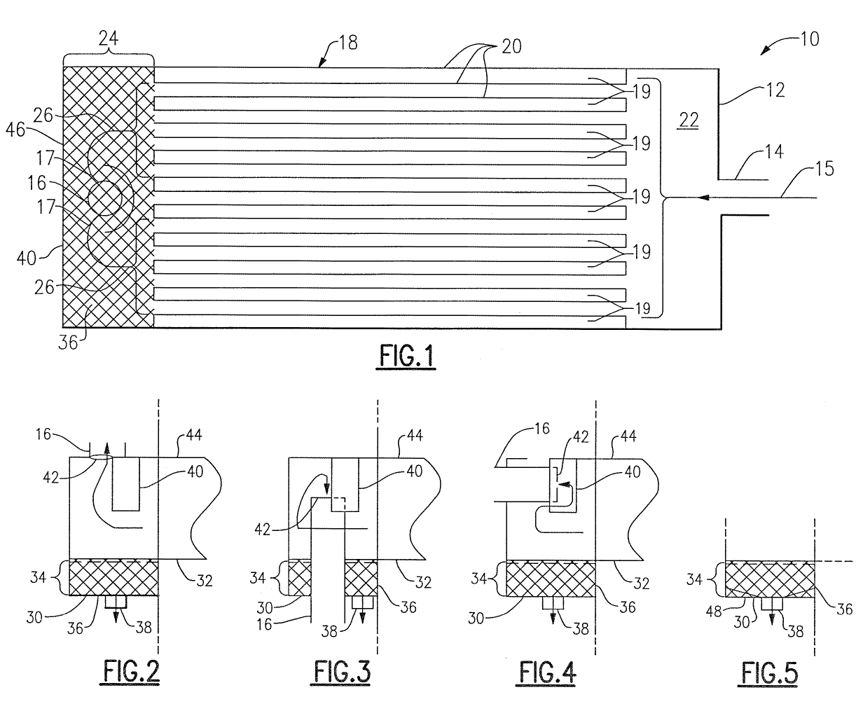

Referring to FIGS. 1 and 2, an improved compressed air aftercooler system 10 for aftercooling and demoisturizing compressed air is shown. By “aftercooling” is meant the removal of the adiabatic heat of compression from compressed air. A housing 12 has an inlet 14 for admitting hot compressed air 15 and an outlet 16 located in the top of the housing 12 for exhausting cooled and demoisturized air 17. Within housing 12 is a heat exchanger 18 known in the art, for example, a conventional bar-and-plate heat exchanger having a plurality of plates 20 for separating a first flow side from a second flow side and for conducting heat therebetween. An intake plenum 22 distributes hot air 15 for flow through the first flow side of heat exchanger 18, and an exhaust plenum 24 collects moisture-laden cooled air 26. Coolant, for example, air at ambient temperature, is passed through the second side of heat exchanger 18 consisting of the vertical channels 19 by conventional pressurizing means (not shown).

The exhaust plenum 24 has a bottom 30 which is lower than the bottom 32 of heat exchanger 18 to form a trough 34. Placed within this trough 34 is moisture separating material 36 preferably made of a high porosity material such as preferably a metallic or plastic mesh. At the bottom of the trough 34 is a water drain 38 for passing the water collected from the hot compressed air 15.

The exhaust plenum 24 also has an arcuate shield 40 positioned between the compressed air entrance 42 of the outlet 16 and the compressed air flowing parallel with the plates 20 which would flow substantially directly across the outlet entrance 42 without the shield 40. The shield 40 extends from the top plate 44 down to approximately the middle of the heat exchanger 18

In operation of system 10, hot moist air 15 as from a compressor enters housing 12 via inlet 14 and is distributed by intake plenum 22 into a first side of heat exchanger 18. The coolant is passed through the channels 19 of heat exchanger 18. Air 15 emerges from heat exchanger 18 as cooled air 26 which is collected in exhaust plenum 24 and exits the aftercooler system 10 through outlet 16. The majority of the moisture which condenses from the compressed air during the cooling process collects on the walls of the plates 20 and flows to the floor 32 of the heat exchanger 18. This condensate as water is pushed by the flow of the compressed air towards and into the exhaust plenum 24 where it flows into the trough 34 and down the drain 38.

While most of the condensate flows to the floor 32 of the heat exchanger 18, some of the condensate remains on the plates 20 and is spewed out from the plates 20 into the exhaust plenum 24. The shield 40 keeps the spewed condensate from directly entering the outlet 16. The spewed condensate hitting the shield 40 either drops directly to the bottom of the trough 30 or is deflected to the inside back wall 46 of the housing 12 where it then drains into the trough 30. The moisture separator 11 essentially prevents the water in the bottom of the trough from being carried by the compressed air through the outlet 16.

FIG. 3 is an alternate embodiment of the invention in which the outlet 16 is located in the bottom of the housing 12.

FIG. 4 is another embodiment of the invention in which the outlet 16 is located in the back wall 46 of the housing 12.

FIG. 5 is a semi-schematic drawing of an alternate embodiment of the lower portion of FIG. 2 in which a slopped bottom 48 has been formed in the trough 30 to better drain the water in the trough 30 into the drain 38.

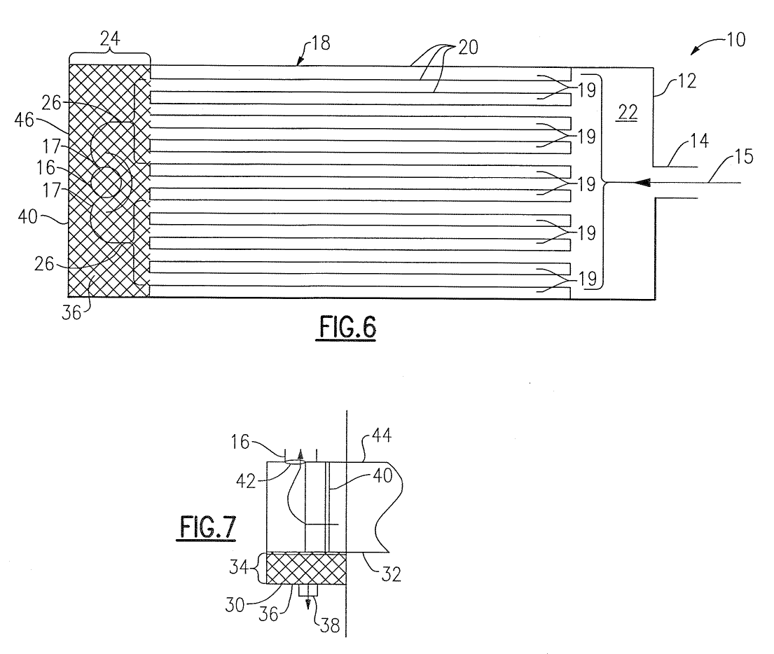

FIG. 6 is a semi-schematic drawing showing the top layout of FIG. 1 with a modified condensate shield 50 which is curved in the middle and has straight plates attached to the ends of the curve. It will be appreciated that other configurations of the condensate shield can be used such as, for example, a V-shaped shield and a non circular shield.

FIG. 7 is a semi-schematic drawing showing a side layout of the compressed air aftercooler of FIG. 6 in which the shield 50 extends down to close to the top of the mesh 36. The shield 40 of FIGS. 1-5 could, in the same manner, extend down to the top of the mesh 36 in other embodiments.

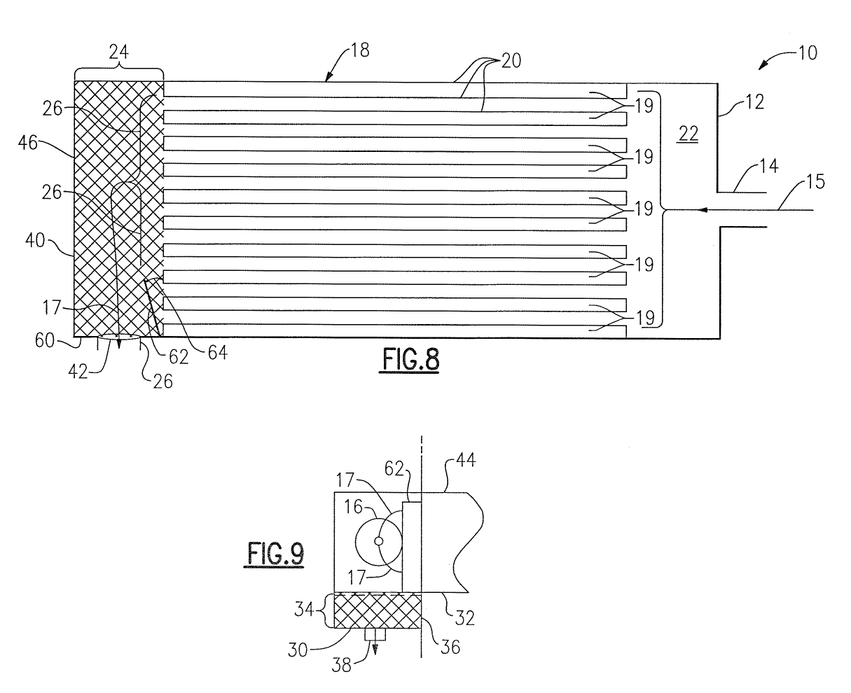

FIG. 8 is a semi-schematic drawing showing a top layout of an alternative embodiment of a compressed air aftercooler and passive moisture-removal improvement in accordance with the invention. In FIG. 8 the output 16 is on the narrow side 60 of the exhaust plenum 24. A rectangular shield 62 has one long edge located at the junction of the side 60 and the cooled air outlet end of the heat exchanger 18. The shield 62 is at an angle 64 with respect to the end of the cooled air outlet of the heat exchanger 18. In the preferred configuration of this alternative embodiment the angle 64 is 15°.

FIG. 9 is a semi-schematic drawing showing a side layout of the compressed air aftercooler of FIG. 8. As shown in FIG. 9 the shield 60 extends from close to the top of the mesh 36 to near the top plate 44.

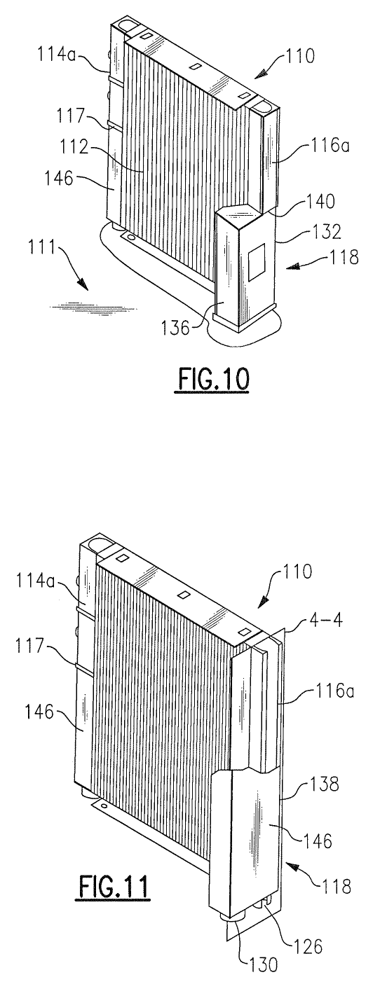

Referring now to the FIGS. 10-14, there is shown yet another possible embodiment of the present invention comprising an aftercooler body 110. Aftercooler 110 generally includes a vertically-oriented core heat exchanger 112, manifolds 14a,b and 16a located on opposite sides of core 112, and a moisture removal plenum 118. In one possible embodiment, plate 117 bisects core 112, dividing core 112 and manifolds 114a,b and 116a into two separate circuits for the cooling of different substances. For example, a first fluid circuit is defined which may be used for cooling oil which has been heated in the air compressor (not shown) which delivers heated, compressed air to the air cooler. The heated oil would then enter manifold 114a at inlet 120 and pass through this first circuit of the heat exchanger 112, exiting manifold 114a at outlet 122 and redirected to the air compressor. An oil drain 124 may also be included in this fluid circuit.

The second fluid circuit (or only fluid circuit depending on the chosen embodiment) is defined with hot, compressed, moisture-laden air entering manifold 14b at air inlet 126 whereupon it is directed through heat exchanger 112, exiting at the series of exchanger air outlets 144 and finally exiting cooler 110 through air outlet 130 located on moisture removal plenum 118. As moisture is removed from hot air within plenum 118, it falls to the plenum bottom 142 and exits through condensate drain 128.

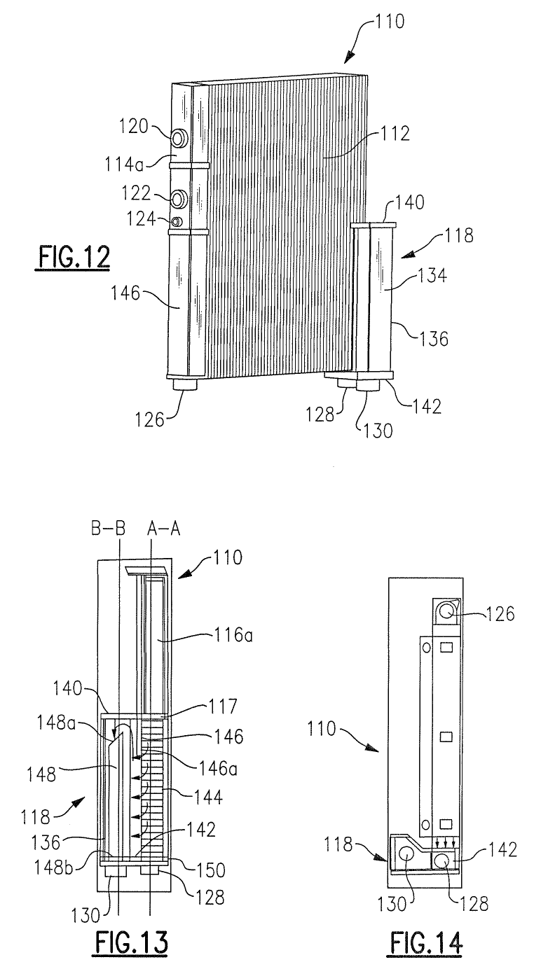

More particularly, plenum 118 comprises an enclosure defined by a front wall 132, a rear wall 134, side walls 136 and 138, a top wall 140, and a bottom wall 142 although it is understood that other plenum configurations are of course possible. Plenum 118 is of a size so as to completely surround cooled air outlets 144. As best illustrated by FIG. 13, cooler 110 is of a configuration intended to be oriented and installed in a vertical manner with respect to a floor. As such, the series of cooled air outlets 144 of the heat exchanger 112, as defined by the stacked plates and fins of the core, may be considered to linearly extend along a vertical axis A-A, substantially perpendicular to a floor 111.

A dry air outlet tube 148 having an inlet 148a and an outlet 148b connected to plenum outlet 130 extends along an axis B-B which is substantially parallel to and laterally offset from axis A-A along which the air outlets 144 of exchanger core 112 extend. It will be appreciated that this embodiment of the invention provides a vertically oriented heat exchanger with integral moisture separator that takes up very little horizontal space.

A shield 146 may be positioned in plenum 118 to extend downwardly between air outlets 144 and the upper segment of air outlet tube 148. Shield 146 is of a length which is suited to block the air from flowing out of core 112 directly into outlet tube 148. As such, the air must travel beneath the bottom edge 146a of shield 146 to reach tube inlet end 148a (see FIG. 13). Shield 146 further assists in removing moisture from the air by slowing down the velocity of the air as it travels to the outlet tube inlet end 148a. This assists in causing the condensate to fall while at the same time not re-entraining condensate that has already been released and accumulated at the plenum bottom 142.

In operation, hot, compressed air enters the aftercooler 110 via inlet 126 where it travels through manifold 114b and is distributed through the core 112 for cooling. The cooled, moisture-laden air exits air outlets 144 into plenum 118. As the cooled air enters plenum 118, it releases moisture in the form of condensate which falls due to gravity to plenum bottom 142. The plenum bottom 142 may be recessed with respect to exchanger core 112 to provide a sump for the collection of condensate should the drain be closed for any reason. Should condensate collect on plenum bottom 142, the condensate will be spaced from the lower-most air outlets 144 which helps discourage condensate from becoming re-entrained into the plenum air flow.

Thus, the cooled, compressed air is directed under shield 146 to reach air outlet tube 148, releasing moisture in the form of condensate as it reaches tube 148. Beveling inlet edge 150 functions to increase the air flow area of the air inlet which further assists in reducing the velocity of the air traveling from the core air outlets 144 to the air outlet tube 148. It is furthermore preferred that the bevel faces away from the shield 146 to provide yet another angle about which the air must travel to reach the inlet since the more angles (i.e. walls) the air must flow around, the more opportunity there is for the condensate to fall from the air flow. Thus, cooled, condensed air exits the system through outlet 130, while condensate which was removed from the air exits the system through condensate outlet 128.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A system for aftercooling and demoisturizing hot compressed air, comprising:
a) a housing containing a heat exchanger for cooling said hot air during passage therethrough, said housing having an inlet, an exhaust plenum and an outlet for passage of said hot compressed air through a first side of said heat exchanger and having a coolant passage through a second side of said heat exchanger; and
b) at least a portion of a bottom of said output plenum being recessed, said recessed portion comprising a moisture separating material located therein and a drain for passing condensate formed in said heat exchanger.

2. A system in accordance with claim 1 wherein said moisture separating material comprises a mesh.

3. A system in accordance with claim 2 wherein said mesh is formed of metal.

4. A system in accordance with claim 2 wherein said mesh is formed of plastic.

5. A system in accordance with claim 1 further comprising a shield located in said exhaust plenum positioned to shield said outlet from spew from said heat exchanger which would otherwise be blown directly across or into an opening of said outlet.

6. A system in accordance with claim 1 wherein the floor of said recess portion is canted toward said drain.

7. A system in accordance with claim 1 wherein coolant passing through said coolant passage is air at ambient pressure and temperature.

8. A system in accordance with claim 5 wherein said shield extends downward from the top of said exhaust plenum.

9. A system in accordance with claim 5 wherein a moisture separating material is located in said recessed portion and said shield extends upward from a region proximate to the top of said moisture separating material.

10. A method for collecting moisture from cooled air from a heat exchanger comprising the steps of:
a) causing said moisture to flow into a recess located at the bottom of an exhaust manifold which receives said cooled air;
b) removing at least a portion of said moisture from said cooled air with a moisture separating material located in said recess and
c) draining said moisture through a drain located in said recess.

11. A method in accordance with claim 10 including the additional step of shielding an opening of said exhaust manifold with a shield positioned to shield said outlet from spew from said heat exchanger which would otherwise be blown directly across or into an opening of said outlet.

12. A system for aftercooling and demoisturizing hot compressed air, comprising:
a) a housing containing a heat exchanger for cooling said hot air during passage therethrough, said housing having an inlet, an exhaust plenum and an outlet for passage of said hot compressed air through a first side of said heat exchanger and having a coolant passage through a second side of said heat exchanger; and
b) a shield located in said exhaust plenum positioned to shield said outlet from spew from said heat exchanger which would otherwise be blown directly across or into an opening of said outlet.

13. A system for aftercooling and demoisturizing hot, compressed air, said system comprising:
a) a heat exchanger core for cooling hot, compressed air entering said core through an air inlet attached to said core, the hot air passing through and exiting said core as cooled air through a series of cooled air outlets arranged along a first vertical axis lying in the plane of said core;
b) a moisture removal plenum attached to said core and completely surrounding said cooled air outlets such that said moisture removal plenum is in fluid communication with said outlets, said plenum having a top wall and a bottom wall; and
c) a dried air outlet tube having an inlet end and an outlet end, said tube positioned within said plenum and extending along a second vertical axis which lies in laterally spaced, parallel relation to said core plane and said first vertical axis;
whereby cooled, compressed air passes from said cooled air outlets into said plenum and is directed into said tube inlet end with condensate in said cooled air falling to said bottom of said plenum due to gravity and directed through a condensate outlet connected to said plenum bottom wall.

14. A system in accordance with claim 13 wherein said bottom wall of said plenum is recessed with respect to said core forming a sump.

15. A system in accordance with claim 13 and further comprising a shield extending downwardly from said plenum top wall between said air outlets and said tube, said shield having a bottom edge, beneath which air must travel to reach the inlet end of said tube.

16. A system in accordance with claim 15 wherein said inlet end of said tube is beveled in a direction away from said cooled air outlets.

17. A system in accordance with claim 16, wherein said heat exchanger is comprised of at least two circuits for cooling said hot, compressed air and another substance. 162243 12
